(19) United States
(12) Patent Application Publication
(10) Pub. No.: US 2026/0063538 A1
(43) Pub. Date: Mar. 5, 2026

(54) APPARATUS FOR MULTIMODAL ANALYSIS OF SAMPLE MATERIAL

(71) Applicant: Bruker Daltonics GmbH & Co. KG, Bremen (DE)

(72) Inventors: Alexander POTTHOFF, Münster (DE); Jens SOLTWISCH, Herten (DE); Marcel NIEHAUS, Bremen (DE); Klaus DREISEWERD, Münster (DE)

(21) Appl. No.: 19/105,408

(22) PCT Filed: Aug. 22, 2022
(86) PCT No.: PCT/DE2022/100627

§ 371 Date: Feb. 21, 2025

(51) Int. Cl. G01N 21/31; G01N 21/17

(52) U.S. Cl. CPC G01N 21/31; G01N 21/17; G01N 2021/1765

(57) ABSTRACT

The invention relates to an apparatus for multimodal analysis of sample material, for example from a tissue, which detects molecular image information from the sample material in a spatially resolved manner, for example using a MALDI time-of-flight mass analyser, records light microscopy image information from the sample material in a spatially resolved manner, and associates the two with improved accuracy to give spatially resolved co-registered overall image information.

### FIELD OF THE INVENTION

The invention relates to an apparatus for multimodal analysis of sample material, for example from a tissue, which detects molecular image information from the sample material in a spatially resolved manner, for example using a time-of-flight mass analyser, records light microscopy image information from the sample material in a spatially resolved manner, and associates the two with improved accuracy to give spatially resolved co-registered overall image information.

### BACKGROUND OF THE INVENTION

The prior art is elucidated hereinafter with reference to one specific aspect. However, this should not be regarded as a restriction. Useful advances on and alterations to the invention may also be applicable beyond the comparatively narrow scope of this introduction and will be immediately apparent to trained practitioners in this field after reading the disclosure of the invention that follows this introduction.

In imaging MALDI mass spectrometry (mass spectrometry imaging=MSI; MALDI=matrix-assisted laser desorption ionization), co-registration of the ion images with high-resolution optical microscope images is an important source of information. Methods used to date for the purpose can be time-consuming and error-prone.

As well as the exact correlation of the plane coordinates xy of each pixel for the co-registration, MALDI-MSI requires information relating to the sample topography for every pixel if possible. On this basis, it is then possible to optimize material ablation and hence data quality. This is especially true of high-and ultrahigh-resolution MALDI-MSI. It is possible here to use what is called transmission geometry, tMALDI. The low depth sharpness of the microscope objectives used, for example 1.6 micrometres in the case of use of a 50× Mitutoyo Plan Apo NUV with infinitely corrected objective, requires exact determination of topography with sub-micrometre accuracy.

In the current state of the art, these two objects of spatially precise superimposition and determination of topography are treated separately and are independently subject to inaccuracies that place limits on informative evaluation.

Various commercially available slide scanners are in use for recording of optical images, e.g. Olympus VS200, Hamamatsu, etc. Slide refers here to the object carrier. These slide scanners are separate assemblies and work predominantly with individual images scanned across the sample surface, which are then conjoined by stitching to form an overall image. This conjoining is based onalready processed image data with inclusion of the discovery of coincident image features, and not on raw data.

Also known is co-registration of externally recorded optical images with ion images by means of teaching marks added in the course of sample preparation. Various mass spectrometer manufacturers sell software programs for this type of multimodal optical/mass-spectrometry imaging. Examples of these are Bruker: flexImaging, or Waters/Micromass: High Definition Imaging.

Co-registration of optical images in MALDI-MSI serves two functions. Firstly, before the measurement, the measurement range is defined with the aid of a co-registered optical scan. Secondly, in multimodal approaches, microscope images recorded before or after the MALDI measurement are used to combine optical and mass spectrometry information. The two functions can be achieved only quite inaccurately and in a time-consuming manner by the methods known for the purpose. For the initial co-registration of optical image (scan) and ablation position in the spectrometer, optical features of an externally recorded image must first be correlated by the user or an automated routine in the real-time image from the internal camera of the mass spectrometer. A first error occurs here in the positioning of the markers in the two images. Especially in the case of pixel sizes of less than 10 micrometres, the optical imaging quality within the mass spectrometer here often does not permit exact assignment. After marking, the optical image is subjected to procedures including stretching without a fixed aspect ratio, rotation and slant correction. These image corrections too always cause artefacts that frequently lead to inexact co-registrations. Such systematic uncertainties in this initial co-registration have the direct consequence that the selected measurement range always has to be selected with a certain safety margin. This prevents the measurement of directly adjoining regions, such that parts of the sample area are left unexamined and extends the measurement times.

In the multimodal interpretation of the data obtained, very exact co-registration is essential. For instance, only precisely correlated images allow a direct comparison of morphological and molecular information. Especially in the case of high-and ultra high-resolution MALDI-MSI (pixel size <10 micrometres), the systematic error here is often a multiple of the pixel size. This requires subsequent correction of the co-registration between microscope image on the one hand and ion distribution images on the other hand. Since both modalities generate their contrast in very different ways, systematic errors here typically remain in the order of magnitude of the pixel size.

Exact co-registration with available methods additionally requires time-consuming and computation-intensive methods based on multiple microscope images before and after the MALDI-MSI, as elucidated in two articles by Nathan Heath Patterson et al. What are described therein are procedures for the registration and analysis of MALDI MSI-to-microscopy data using nondestructive MSI-compatible wide-field autofluorescence (AF) microscopy in combination with computer-assisted image registration (Anal. Chem. 2018, 90, 12395-12403), and a further-developed histology-led platform that uses MSI-compatible AF microscopy prior to histological staining or MSI measurement (Anal. Chem. 2018, 90, 12404-12413).

The paper by Michael J. Taylor et al. (Metabolites 2021, 11, 200) is concerned with laser ablation electrospray ionization mass spectrometry (LAESI-MS) for single-cell metabolomics. What is reported is the integration of a microscope into the optical pathway of an LAESI source in order to conduct a visually monitored in situ single-cell analysis to promote understanding of intercellular differences within large cell populations under ambient conditions. The microscope registers optical images across the sample surface in individual tiles that are then “stitched together” by image processing programs to give an overall image.

In the method presented by Michael J. Taylor et al., illumination and observation coaxially with the ablation laser beam pathway are described in a LAESI experiment. An autofocus routine based on image sharpness is also used here. This frontal observation in reflected light is unsuitable for MALDI samples owing to the largely opaque matrix coating. Furthermore, observation along the sample normal would be impossible or implementable only with great difficulty since this space is required for ion extraction in MALDI. Observation at an angle greater than 0°to the sample normal leads to image distortions that would have to be corrected. The required shift in the individual images relative to one another means that sufficiently precise co-registration is not possible by this method.

As well as co-registration, pixel-sharp determination of topography may be an important prerequisite for ultrahigh-resolution MALDI-MSI, for example in the examination of highly profiled tissue such as the retina. Current methods for tissue samples or other mass spectrometry samples perform this determination of topography independently. The accuracy of the topographic information available in the spectrometer is thus based partly on error-prone co-registration. Moreover, customarily used methods are not exact enough for the low depth sharpnesses in the lower micrometre range that are used in tMALDI, and are limited to relatively large areas and hence not pixel-sharp. For example, in the timsTOF fleX from Bruker, by means of an auxiliary laser, a stripe pattern is projected on the sample surface. Using this pattern, it is possible to determine the distance between the focal plane of the laser and the sample surface accurately to about 5 micrometres. This accuracy is not high enough for the low tMALDI depth sharpnesses, such as 1.6 micrometres as calculated by way of example above for the 50× objective. In addition, with the aid of this method, averaging is effected over an area of about 1 millimetre×1 millimetre. Structures that are smaller are thus averaged out and escape evaluation.

The study by Mario Kompauer et al. (Nat. Methods 2017, 14, 1156-1158) suggests performing a time-consuming autofocus routine in the height profile determination with a spot light source for each pixel, in order to resolve small structures. The pixel size here is currently limited to about 20 micrometres. Related to this is patent publication EP 3 306 639 A1 (corresponding to U.S. Pat. No. 10,964,519 B2), which has the aim of providing an apparatus that enables simultaneous analysis of two-dimensional spatial chemical composition and the topography of a sample.

Also briefly acknowledged hereinafter are some prior art documents that may be of relevance to the subject-matter of the present disclosure:

The paper by F. Hillenkamp et al. (Appl. Phys. 8, 341-348 (1975)) presents a high-sensitivity laser microprobe mass analyzer (LAMMA), which has been specially designed for the examination of biological sample material. Building on this pioneering study, the article by H. Vogt et al. (Fresenius Z. Anal. Chem. 308, 195-200 (1981)) describes principles and technical features of the laser microprobe mass analyzer (LAMMA) 500, which was equipped with a light microscope for visual observation of the sample in reflection through a coated electron-microscope grating as object carrier.

The paper by Bernhard Spengler et al. (J Am Soc Mass Spectrom 2002, 13, 735-748) relates to a scanning microprobe matrix-assisted laser desorption ionization (SMALDI) mass spectrometer for resolved LDI and MALDI surface analysis in the sub-micrometre range. For overview observation, it is possible to image the sample with a standard light microscope with a magnification of about 400×. A region of about 500 micrometres×400 micrometres is displayed on a video monitor. The sample is illuminated and exposed not from the side but through the objective owing to geometric constraints. Since the objective has not been corrected for chromatic aberration, it was possible to use only monochromatic light, namely a He—Ne laser having an output light power of 15 mW, for the imaging of the sample.

Patent publication US 2003/0222212 A1 discloses a method and system for creating a correlated optical image of an ion desorption region of a sample substrate which is probed using light having foci down to the micrometre or sub-micrometre range for matrix-assisted laser desorption/ionization (FIG. 3).

Patent publication US 2006/0289734 A1 presents a method of generating a sharp image of a region on a sample plate for a matrix-based ion source, comprising: positioning the region in a field of view of an imaging device; creating a first image having an in-focus region and an out-of-focus region using the imaging device; creating a second image having an in-focus region and an out-of-focus region using the imaging device; and creating a final in-focus image using the in-focus regions of the first and second images.

U.S. Pat. No. 7,180,058 B1 protects an ion source for a mass spectrometer, comprising: a radiation source for creation of a beam of rays; beam focusing optics configured such that they focus the beam of rays onto a sample disposed on a front surface of a sample carrier. The beam focusing optics have a focal length of less than 25 millimetres and are positioned adjoining a rear surface of the sample carrier. The sample carrier is transparent at the wavelength of the beam of rays, in order to transmit the beam of rays. Also included is an ion optics device which is positioned adjoining the front surface of the sample carrier and is configured such that it transports ions that are created by irradiation of the sample. Also included are viewing optics for detection of an image of the sample which is disposed adjoining the rear surface of the sample carrier.

Patent publication DE 10 2007 006 933 A1 (corresponding to US 2008/0191131 A1 and GB 2 446 699 A) sets out a method by which, in a MALDI axial time-of-flight analyser, the distance between the sample surface and the first acceleration electrode in the flight path can be adjusted with the aid of knowledge of the position of the sample surface, which is ascertained by evaluation of the images from a digital camera, relative to the digital camera.

Patent publication US 2009/0146053 A1 describes, for a mass spectrometer for performance of a mass analysis with simultaneous microscope observation of a two-dimensional region of a sample, separation of the observation position for selection of a target region with simultaneous observation of an image of the sample recorded with a CCD camera from the analysis position for performance of the mass analysis in which laser light is released onto the sample. The sample is positioned on a stage, which is to be movable precisely between the observation position and the analysis position by a stage drive mechanism.

Patent publication US 2011/0315874 A1 discloses a mass spectrometer which is said to be capable of performing imaging mass spectrometry efficiently over a spatial region that extends beyond the observation field of a microscope observation unit.

Patent publication US 2011/0266438 A1 discloses a mass spectrometer which is said to be capable of obtaining a microscopy observation image with high spatial resolution in real time during a mass analysis without impairing the analysis. An opening is formed in a stage, on which a transparent sample plate is positioned. A microscope observation unit comprising an optical observation system and a CCD camera is provided beneath the stage in order to observe the reverse side of the sample through the opening in the stage and the transparent sample plate. The image observed is displayed on the screen of a display unit.

In the study by Andre Zavalin et al. (J Mass Spectrom. 2012 November; 47 (11), 1473-1481), the authors conclude that a transmission geometry configuration allows focusing of a laser beam in the ion source of a MALDI mass spectrometer to dimensions of less than 1 micrometre, which is said to enable direct imaging of heterogeneous tissue sections and individual cells with sub-cellular resolution. The sub-cellular MS images were validated by co-registration of individual images that were obtained by microscopy methods, e.g. optical phase contrast, DIC (differential interference contrast) and bright-field images. Individual optical microscope images were recorded both before and after the MS imaging experiment. FIG. 1 of the present disclosure shows an adaptation of FIG. 2 of this publication. The reference numerals therein have the following meanings: 1—chamber; 2—UV laser; 3—stop; 4—beam attenuator; 5—white light source; 6—CCD camera; 7—xy displacement stage; 8—observation window on reverse side; 9—microscope objective; 10—time-of-flight analyser tube.

The study by Marcel Niehaus et al. (Nat. Methods 2019, 16, 925-931) is concerned with MALDI-2 mass spectrometry in transition mode for imaging of cells and tissues with sub-cellular resolution. Microscope observation of the sample in transmitted light is possible via the same beam path of the MALDI laser using a single LED as light source, a beam divider and a CCD camera (charge-coupled device).

In view of the above observations, there is a need to improve the co-registration of spatially resolved molecular image information and spatially resolved microscope image information, especially with regard to its accuracy and the complexity involved in the configuration of the optics assemblies. Further objects to be achieved by the invention will be apparent to the person skilled in the art directly on reading the disclosure that follows.

### SUMMARY OF THE INVENTION

In a first aspect, the present disclosure relates to an apparatus for multimodal analysis of sample material, comprising:—a desorption optics system arranged and designed to subject sample material disposed on one side of a sample carrier to a first radiation and to bring about desorption of the sample material into the gas phase, with ionization of the desorbed sample material,—an analyser disposed at a distance from the sample carrier and designed to receive the desorbed and ionized sample material and to process it to spatially resolved molecular image information,—a transmission reflected light optics system arranged and designed to record light microscopy image information from the sample carrier and sample material in a spatially resolved manner using a second radiation in reflection through the transparent sample carrier, where the second radiation is emitted by a light source disposed on a side of the sample carrier facing away from the sample material and designed such that the second radiation, when incident on the sample carrier, does not pass through any optics component through which the first radiation passes when incident on the sample carrier, and—a computation unit arranged and designed to communicate with the desorption optics system, the analyser and the transmission reflected light optics system, and to associate the spatially resolved molecular image information and the spatially resolved light microscopy image information to give spatially resolved co-registered overall image information.

Sample material used may especially be a microtomed tissue section. Examples of this are brain tissue and retinal tissue. The sample material can especially be cut from a frozen piece of tissue or a formalin-fixed, paraffin-embedded (FFPE) tissue, which may require further processing steps prior to analysis, for example “deparaffinization” and “decrosslinking”, also referred to as antigen retrieval. The thickness of a tissue section to be analysed may be 2-20 micrometres, especially 2-15 micrometres for tMALDI applications. For reflected-light or reflection MALDI, the sections may also be thicker, e.g. 2-40 micrometres. Multimodal analysis of tissue sections, especially in the field of clinical use for determination of pathological states of a tissue, and the distinction thereof from non-pathological states, or of the cell response to the administration of pharmaceutical substances, is gaining ever greater significance.

The desorption optics system may comprise a laser desorption ion source (LDI), which may especially be designed as a MALDI source. Useful methods of ionization, depending on the requirement, are a MALDI method in reflected light or in transmitted light. The MALDI method entails a particular sample preparation with a light-absorbing matrix substance, e.g. sinapic acid, 2,5-dihy-droxybenzoic acid, α-cyano-4-hydroxycinnamic acid or 2,5-dihydroxyacetophenone, all of which absorb strongly in the ultraviolet spectral region, for example laser light from a nitrogen laser at a wavelength about 337 nanometres or a frequency-tripled solid-state Nd: YAG laser at about 355 nanometres.

The sample material may be subjected to the first radiation in pulsed form. The frequency of a pulse sequence may be in the region of a few hertz, e.g. 1-20 pulses per second, up to 10³ or 10⁴ hertz.

The analyser may be a mobility analyser, mass analyser or combined mobility-mass analyser. In general terms, ion spectrometry analyses and test methods can be said to include mobility separation, mass separation or a combination of the two.

An ion mobility analyser separates charged molecules or molecular ions according to their collision cross section-to-charge ratio, occasionally referred to as Ω/z or σ/z. The basis for this is the interaction of the ion species with an electrical field that couples to the charge of the ions, under the simultaneous action of a buffer gas that acts on the average cross-sectional area of the ion. In particular, drift tube mobility separators with a static electrical field gradient are known, which drive ions through an essentially stationary gas, resulting in the drift speed of an ion species from the driving force of the electrical field and the slowing force of the impacts with the gas particles. Likewise familiar are trapping ion mobility separators (TIMS) with a constant laminar gas flow that drives the ions onward, counteracted by an electrical field gradient which is varied stepwise with a correspondingly variable slowing force. Travelling wave mobility separators may also be mentioned.

A mass analyser in turn separates charged molecules or molecular ions according to their mass-to-charge ratio, typically referred to as m/z. It is possible to use time-of-flight analysers, for which it is possible to provide either linear or reflector setups and/or those having axial or orthogonal acceleration into the time-of-flight zone. Other types of mass-dispersing separators can also be used, e.g. quadrupole mass filters (“single quads”), triple quadrupole analysers (“triple quads”), ion cyclotron resonance cells (ICR), Kingdon-type analysers such as the Orbitrap® (Thermo Fisher Scientific) and others. It will be apparent that separators of the aforementioned types may be coupled in order to be able to separate ion species multidimensionally, i.e. according to more than one physicochemical property such as m/z and Ω/z or σ/z.

Association of spatially resolved molecular image information and spatially resolved light microscopy image information may mean superimposing the two types of image information accurately in space and creating an image or graphic representation thereof, for example on a computer screen. In this way, a user may be empowered to recognize visually corresponding and/or differing feature intensities or structures in the image information from the various modalities in a spatially resolved manner. Associations in the context of the present disclosure may alternatively include further processing of the image information, for example the creation of an overview map of the sample material on which an index is plotted in a grey or colour scale, which results from computation of the spatially resolved intensities of one or more ion species of interest m/z and the spatially resolved intensities of one or more wavelengths λ from the electromagnetic spectrum. An ion species of interest may, for example, be a biomolecule or biopolymer, such as a protein, peptide, lipid, polynucleotide or polysaccharide. The spatially resolved, co-registered overall image information preferably covers the whole sample material two-dimensionally, for example the whole area of an analysed tissue section. The image information patterns of the various modalities are normally of different dimensions; the optical modality permits a finer pattern, i.e. image elements with smaller dimensions, than the mass analysis modality. According to the configuration of the light microscopy observation optics, optical resolution is regularly in the sub-micrometre range, e.g. at 500-700 nanometres, whereas the pixel size (or lateral resolution) for mass analysis ablation is typically in the low micrometre range, e.g. 1-10 micrometres. In particular embodiments, the association may include adjustment of the image information data from the more highly spatially resolved modality to the pattern of the modality with lower resolution.

In various embodiments, the desorption optics system may have a transmitted light optics system arranged and designed such that the first radiation is incident on the sample material after passing through the sample carrier. The configuration as transmitted light optics system makes it possible to keep the ion formation region clear of beam-guiding elements that could interfere with ion extraction. Moreover, a transmitted light optics system enables stronger focusing of the first radiation for the locally very limited ablation of the sample material, such that distinctly higher spatial resolutions can be achieved than with reflected light optics systems such as reflection MALDI. With a laser beam, it is possible to achieve ablation areas and hence image element or pixel areas with diameters in the single-digit micrometre range and, with particularly careful fine adjustment—the sub-micrometre range. The terms “image element” and “pixel” have the same meaning in the present disclosure and are used synonymously.

In various embodiments, an observation axis of the transmission reflected light optics system and an optical axis of the first radiation on incidence on the sample carrier may be brought into line one on top of another using a dichroitic and/or dielectric mirror. This enables dual use of some optics components such as lenses and/or mirrors in the guiding of the first beam on incidence onto the sample carrier and of the second beam in reflection by the sample material through the sample carrier.

In various embodiments, the apparatus may be designed for use of a conductively coated glass plate as sample carrier. Indium tin oxide (ITO)-coated glass plates are particularly suitable, since, by virtue of their conductivity, they permit generation of an electrical reference potential on their surface that bears the sample material, which is helpful in the further processing of the ionized sample material produced, based on electrical potentials and fields.

In various embodiments, the light source may be arranged and designed such that the spatially resolved light microscopy image information is recorded in a substantially shadow-free manner. In a greatly magnified image, the surface of the sample material facing away from the sample carrier, possibly covered by matrix substance, may have a highly fissured appearance. Strongly directed illumination of such a markedly structured surface can confuse automated image evaluation algorithms by shadowing, since the actual topography can be clearly recognized only on the side of the structures facing the incidence of light, whereas the regions in shadow give barely any reference points for image-based feature recognition owing to the small differences in intensity and resultant uniform appearance. The light source may be in multipart form in that it has more than one light generator, the radiation from which is then combined for observation of the spatially resolved light microscopy image information in the sample material, or else it may have one light generator, in which case the light therefrom is spatially fanned out using one or more diffusers before it is radiated onto the sample material.

In various embodiments, the light source may be annular, and an observation axis of the transmission reflected light optics system may be in encircling form. What is enabled in particular by an annular form around the observation axis is the incidence of light on the reverse side of the sample carrier such that an observation point, for example an image element or pixel having an area of 0.01-1 square micrometre, on the possibly highly structured sample material can be irradiated with light from an extended solid angle range and accordingly at a multitude of different angles of incidence. Consequently, such a configuration is capable of avoiding shadowing and the aforementioned associated adverse consequences.

In various embodiments, the light source may comprise a multitude of light-emitting diodes. The light from each individual light-emitting diode may contain a mixture of different wavelengths that together create a white colour impression. But it is also possible to configure one or more light-emitting diodes such that they emit light with a different non-white colour characteristic, for example one or more of the complementary colours red-cyan, green-magenta and blue-yellow. Monochromatic light facilitates the optical construction for beam guiding since the optics components used need not handle an extended wavelength range, but can be optimized for narrowband use. Using light of different colours for the recording of the spatially resolved microscope image information may have advantages for the perception and automated evaluation of specific sample features. For example, it may be simpler with monochromatic light to locate contrast or image sharpness maxima in the optical images. It is possible for all light-emitting diodes to have the same design, for example with white light characteristics. In variants, it is also possible to juxtapose light-emitting diodes of different colours that together—if all activated and emitting light—create light in a first colour, e.g. white, and—if some are not activated—create light in a different colour, e.g. green. A user is able to choose, via selective switching, colour characteristics that are best suitable for a planned experiment and the sample material used without having to perform complex modifying operations on the apparatus.

In various embodiments, the light source may be arranged and designed such that the second radiation, when incident on the sample carrier, does not pass through any imaging and/or deflecting optics component. This simplifies the setup of the transmission reflected light optics, and enables positioning of the light source in the immediate proximity of the sample carrier or holder thereof. Optics components here especially mean refractive and reflective (mirroring) components such as lenses, mirrors, optical fibres etc. A microscope objective in its entirety should also be regarded as an optics component. Optics components in the context of the present disclosure should not be considered to include purely transparent plates, for example made of glass, through which light or electromagnetic waves pass under largely paraxial conditions, i.e. at angles that differ only slightly from a surface normal of the plate. In particular, a sample carrier holder that supports the sample carrier, for example in a transmitted light desorption optics system, in which the first beam is incident on the reverse side of the sample carrier, should not be regarded as an optics component in the context of the present disclosure. Nor should the transparent sample carrier be regarded as an optics component in the context of the disclosure.

In various embodiments, the apparatus may further include movement mechanics for the sample carrier, arranged and designed to move the sample carrier in at least one spatial direction with respect to a direction of incidence of the first radiation and/or of the second radiation. The movement mechanics may especially comprise an xy displacement stage on which the sample carrier is placed and which spatially displaces the sample carrier together with sample material placed thereon in two spatial directions x and y that extend substantially at right angles to a surface normal of the sample carrier and substantially at right angles to a direction of microscope observation. The movement mechanics are preferably also designed to spatially displace the sample carrier in a third spatial direction z at right angles to the aforementioned spatial directions x and y. In particular, the movement mechanics may be designed and arranged to be operated under reduced pressure. A typical pressure employ able for vacuum MALDI, for example, is substantially greater than a high vacuum (>10⁻³ hectopascal) and lower than about 10² hectopascal (<atmospheric pressure), e.g. 0.1-10 hectopascal. In the case of embodiments using vacuum MALDI, local desorption and ionization of the sample material take place in a gas-tight and continuously pumped reduced pressure chamber, which is fluidically connected to the analyser for onward conduction of the locally desorbed and ionized sample material.

In various embodiments, a mode of operation of the computation unit, of the desorption optics system and of the transmission reflected light optics system may include recording the spatially resolved light microscopy image information before and/or after exposure of the sample material to the first radiation. By virtue of the specific execution of the apparatus with a transmission reflected light optics system adjoining the reverse side of the ion source region for observation and recording of spatially resolved light microscopy image information from the sample material, it is possible to detect light images and molecular images in the same holder of the sample carrier, effectively in the same mounting, and in the same absolute positional coordinate system. As a result, not only are the positional coordinates of the corresponding image elements or pixels known very accurately, but they also correspond to one another for the different modalities: light microscopy and ion analysis. The only variance that could occur here is any incorrect steps by the movement mechanics in the case of repeated addressing of a particular position. However, there are available displacement stages which, according to manufacturer specification, have positional accuracy in the double-digit nanometre range, for example piezoelectrically operated displacement stages from the manufacturer SmarAct (Oldenburg, Germany), especially the CLL, CLS and SLC series with a positional accuracy of 40 nanometres. Furthermore, it is possible to reliably correct any inaccuracies that occur in the positioning by known monitoring methods and optionally positional correction of the movement mechanics.

In various embodiments, the apparatus may also include an imaging objective arranged in such a way that the light source lies between the sample carrier and the objective along an observation axis of the transmission reflected light optics system. The imaging objective may be designed to image the first radiation on incidence on the sample carrier and the second radiation after passage through the sample and reflection from the sample material. The objective may especially have dual imaging properties if a transmitted light desorption optics system is used, in that it firstly guides the light reflected back by the sample material through the sample carrier, which is used for ascertaining of the spatially resolved light microscopy image information, to a camera used for the recording, and optionally conditions it, and secondly conditions the first radiation for incidence on the reverse side of the sample carrier and the sample material disposed on the other side, for example to focal sizes having diameters in the region of a few micrometres or even lower.

In various embodiments, the light source and the imaging objective may be designed as an integral assembly. The light source is preferably integrated into a portion of an objective body that faces the reverse side of the sample carrier. Such a space-saving configuration reduces the distance between the light source and the sample carrier, and permits irradiation of the sample material with the light emitted by the light source without further beam-guiding and beam-forming optics components.

In various embodiments, a mode of operation of the computation unit and of the transmission reflected light optics system may include recording the spatially resolved light microscopy image information by sequentially scanning a multitude of xy individual image areas on the sample material and computationally conjoining the isolated xy individual image information thusly obtained. The individual image information may be conjoined on the basis of the raw data detected for an overall image covering the whole sample material. There is no need for prior image data processing that could impose further inaccuracies on the light microscopy data, which would then be propagated through further processing steps. In this way, it is possible to improve the imaging quality of the overall optical image. Furthermore, for the conjoining, there is no need to provide overlap regions of the individual images with subsequent feature matching in the overlap regions, since the position of the individual image areas is very precisely known by virtue of the high positioning accuracy of the movement mechanics.

In a second aspect, the present disclosure relates to an apparatus for multimodal analysis of sample material, comprising:—a desorption optics system arranged and designed to subject sample material disposed on one side of a sample carrier to a first radiation and to bring about desorption of the sample material into the gas phase, with ionization of the desorbed sample material,—an analyser disposed at a distance from the sample carrier and designed to receive the desorbed and ionized sample material and to process it to spatially resolved molecular image information,—a transmission reflected light optics system arranged and designed to record light microscopy image information from the sample carrier and sample material in a spatially resolved manner using a second radiation in reflection through the transparent sample carrier, where the second radiation is emitted by a light source disposed on a side of the sample carrier facing away from the sample material and designed such that the spatially resolved light microscopy image information is recorded in a substantially shadow-free manner, and—a computation unit arranged and designed to communicate with the desorption optics system, the analyser and the transmission reflected light optics system, and to associate the spatially resolved molecular image information and the spatially resolved light microscopy image information to give spatially resolved co-registered overall image information, wherein a mode of operation of the computation unit and of the transmission reflected light optics system includes recording the spatially resolved light microscopy image information by sequentially scanning a multitude of xy individual image areas on the sample material and computationally conjoining the isolated xy individual image information thusly obtained.

In various embodiments, a mode of operation of the computation unit and of the transmission reflected light optics system may include scanning a multitude of xy individual image areas in a third spatial direction z for a maximum contrast and/or image sharpness position. A preferred mode of operation of the computation unit and of the transmission reflected light optics system may include using the maximum contrast and/or image sharpness position (i) to ascertain spatially resolved height profile information of the sample material above the sample carrier and/or (ii) to assemble an optical overall image having an image component from a z position of the respective maximum contrast and/or image sharpness position in each image element (focus stacking).

In the case of sample material having marked differences in height across the sample carrier, it may be useful to adjust the ablation position on exposure of the sample material to the first radiation in order to maintain uniform desorption conditions over an extended area, for example in the order of magnitude of square millimetres to square centimetres for microtomed tissue sections. A mode of operation of the computation unit and of the desorption optics system may consequently include using the maximum position of contrast and/or image sharpness in the exposure of the sample material for an adjustment of a position of the (i) focus of the first radiation and/or (ii) sample carrier in the third spatial direction z.

In a third aspect, the present disclosure relates to a method of multimodal analysis of sample material, comprising:—locally exposing the sample material disposed on one side of a sample carrier to a first radiation and bringing about local desorption of the sample material into the gas phase, with ionization of the locally desorbed sample material,—receiving and processing the locally desorbed and ionized sample material to give spatially resolved molecular image information using an analyser disposed at a distance from the sample carrier,—recording spatially resolved light microscopy image information from the sample carrier and sample material using a second radiation in reflection through the transparent sample carrier, where the second radiation is emitted by a light source disposed on a side of the sample carrier facing away from the sample material and designed such that the second radiation, when incident on the sample carrier, does not pass through any optics component through which the first radiation passes when incident on the sample carrier, and—associating the spatially resolved molecular image information and the spatially resolved light microscopy image information to give spatially resolved co-registered overall image information.

In a fourth aspect, the present disclosure relates to a method of multimodal analysis of sample material, comprising:—locally exposing the sample material disposed on one side of a sample carrier to a first radiation and bringing about local desorption of the sample material into the gas phase, with ionization of the locally desorbed sample material,—receiving and processing the locally desorbed and ionized sample material to give spatially resolved molecular image information using an analyser disposed at a distance from the sample carrier,—recording spatially resolved light microscopy image information from the sample carrier and sample material using a second radiation in reflection through the transparent sample carrier, where the second radiation is emitted by a light source disposed on a side of the sample carrier facing away from the sample material and designed such that the spatially resolved light microscopy image information is recorded in a substantially shadow-free manner, and—associating the spatially resolved molecular image information and the spatially resolved light microscopy image information to give spatially resolved co-registered overall image information, wherein the spatially resolved light microscopy image information is recorded by sequentially scanning a multitude of xy individual image areas on the sample material and computationally conjoining the isolated xy individual image information thusly obtained.

In various embodiments, the method according to the third and/or fourth aspect of the present disclosure may be performed using an apparatus as elucidated above.

### BRIEF DESCRIPTION OF THE FIGURES

For better understanding of the invention, reference is made to the figures that follow. The elements in the figures are not necessarily shown true to scale, but are intended primarily to illustrate the principles of the invention (schematically for the most part). In the figures, mutually corresponding elements in the different views are identified by the same reference numerals.

FIG. 1 shows a setup of a tMALDI ion source together with integrated light microscopy observation modality from the prior art.

FIG. 2A is a schematic illustration of the desorption and ion generation region including connected optics systems of an apparatus according to principles of the present disclosure in an isometric view.

FIG. 2B shows a cross section of the desorption and ion generation region from FIG. 2A in a first alignment.

FIG. 2C shows the cross section of the desorption and ion generation region from FIG. 2B in a second, different alignment.

FIG. 3A shows a microscope objective into which a multipart light source for the recording of light microscopy image information is integrated, in an isometric view.

FIG. 3B shows a cross section of the microscope objective from FIG. 3A.

FIG. 4 shows the creation of an overall light microscopy image from a multitude of individual light microscopy area images on the sample material according to principles of the present disclosure.

FIG. 5 illustrates a method based on focus stacking, and determination of a depth or profile map of profiled sample material across a sample carrier according to principles of the present disclosure.

FIG. 6 illustrates the association of spatially resolved light microscopy image information with spatially resolved molecular image information to give spatially resolved co-registered overall image information according to principles of the present disclosure.

FIG. 7 shows a MALDI time-of-flight mass analyser with a conventional setup, suitable for implementation of principles of the present disclosure.

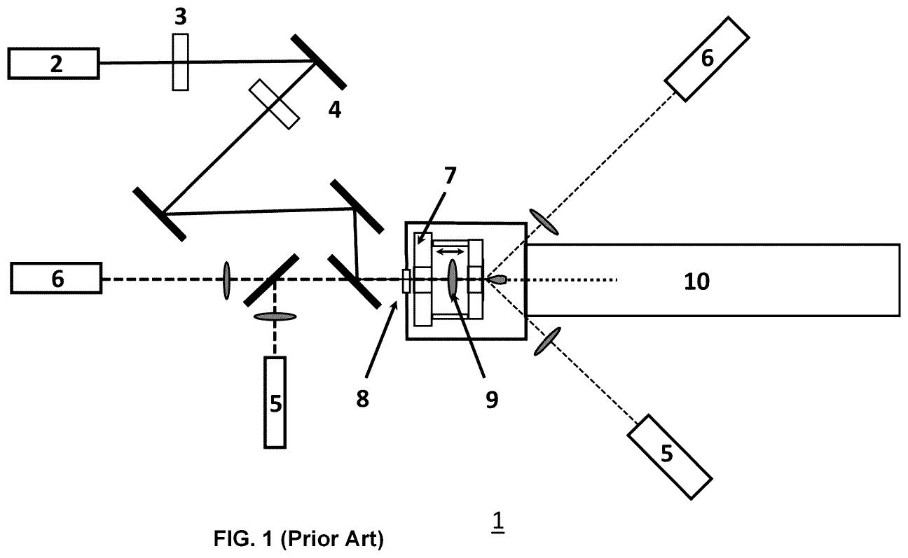

### DETAILED DESCRIPTION

While the invention has been described and elucidated using a number of embodiments, experts in the field will recognize that various alterations can be undertaken in form and detail without departing from the scope of the technical teaching defined in the appended claims.

In the context of this description, various central terms are used, which are briefly elucidated hereinafter especially for optical or microscopy viewing. A pixel/image element refers to the smallest unit of an image. Pixel sizes in the optical/microscopic modality are generally smaller than in the corresponding molecular images. The size of the sample material area which is imaged in an optical pixel is dependent on the sensor size of the camera used and the optical image properties, and may, for example, be 100×100 square nanometres. A single image is an optical image which is recorded of an individual image area using a camera with a single shot by the observation optics. Typical edge lengths of such an area are 30-200 micrometres. The overall optical image is the mosaic-like composition of multiple individual images in order to obtain an overview, and may comprise the whole sample material with edge lengths of a few millimetres or even centimetres. There is a detailed description of the terms in the paragraphs that follow.

With the aid of the invention, it is possible to record highly resolved optical images directly in the ion source of a mass analyser. This means that the absolute positional coordinates for the spatially resolved light microscopy image information and the spatially resolved molecular image information correspond to the laboratory positional coordinate system and hence are identical or congruent. This intrinsically enables virtually perfect co-registration with the ion image recorded in the same source. Errors may be kept within an order of magnitude of less than 100 nanometres, which corresponds to an accuracy less than the customarily used mass analysis pixel edge length (e.g. ˜0.5-10 micrometres for tMALDI, ˜5-100 micrometres for reflected light or reflection MALDI). In addition, with the aid of the newly introduced optical observation, the sample topography can be determined in a pixel-sharp manner and with high resolution.

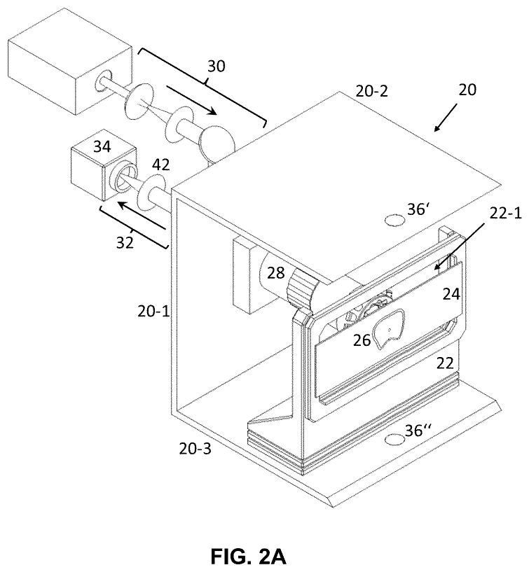

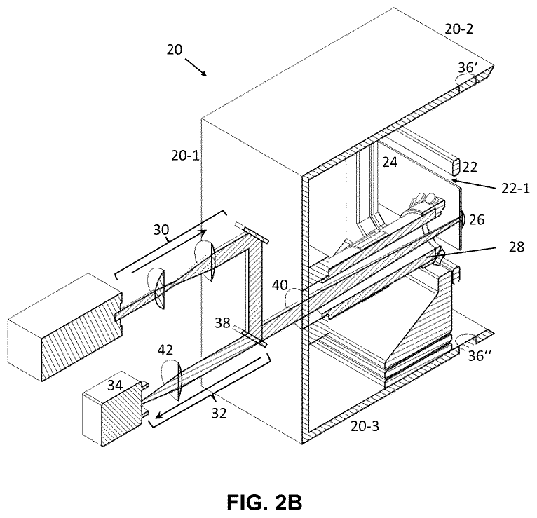

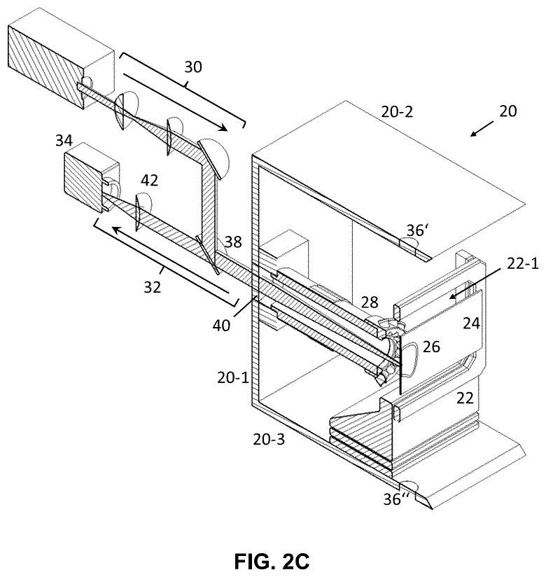

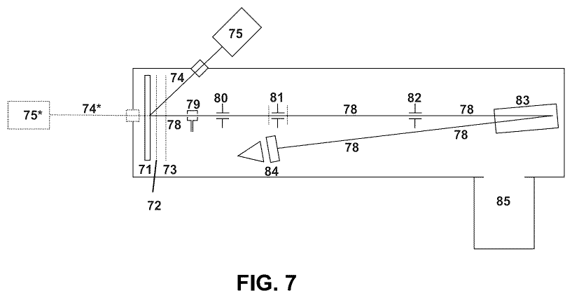

FIGS. 2A-C schematically illustrate a working example of an apparatus according to principles of the present disclosure in various views, and concentrate on one ion source region. By contrast, devices for further processing of ionized sample material are not shown in FIGS. 2A-C. For contextualization, reference is made to FIG. 7, which is to be elucidated further down.

FIG. 2A indicates a reduced pressure chamber 20, which is sealed airtight from the surrounding atmosphere and can be kept using suitable reduced pressure generators, for example pumps, at a pressure between 10⁻³ and 10² hectopascal: a pressure range in which vacuum MALDI can be performed. For the sake of clarity, some side walls of the chamber 20 have been omitted in the diagram; only the back wall 20-1 and the upper and lower walls 20-2, 20-3 are visible. Disposed within the chamber 20 is an xyz displacement stage 22 on which a sample carrier 24 may be placed. The displacement stage 22 is mounted on the lower wall 20-3 of the chamber 20 and designed such that it has a large opening 22-1 through which radiation is directed onto the sample carrier 24 incidentally from the reverse side, i.e. off-side the surface on which the sample material 26 is placed. In this arrangement, the sample carrier 24 lies on the edges around the opening 22-1.

A microscope objective 28 is mounted on the rear wall 20-1 between the rear wall 20-1 of the chamber 20 and the displacement stage 22, and extends as far as just in front of the opening 22-1 in the displacement stage 22. Details of the beam-guiding and optics components in the objective 28 are not shown for the sake of clarity.

Beyond the rear wall 20-1 of the chamber 20, two beam paths 30, 32 are indicated, which are assigned firstly to a transmitted light desorption optics system and secondly to a transmission reflected light optics system. The beam paths 30, 32 contain multiple beam-guiding and beam-forming components such as lenses and deflecting mirrors, which ensure that the first radiation 30 required for the desorption of sample material 26 is guided to the sample carrier 24, and the second radiation 32 reflected back by the sample material 26 through the sample carrier 24, which is required for the recording of the spatially resolved light microscopy image information, to a camera 34.

In the upper and lower walls 20-2, 20-3 of the chamber 20, two windows 36′, 36″ are indicated, by means of which a third radiation, for example a laser beam for the post-ionization of netrally desorbed sample material, can be coupled into and out of the reduced pressure chamber 20 and focused into a desorption cloud above the section of the exposed sample material 26. Details of this method, called MALDI-2, can be found, for example, in the article by Jens Soltwisch et al. (Science, 10 Apr. 2015. Vol 348 Issue 6231, 211 ff.), or else the study by M. Niehaus et al. that was mentioned in the introduction for a tMALDI setup.

The setup can be divided into two parts, or two beam paths 30, 32. The observation beam path 32 and the laser beam path 30 are brought into line one on top of another on their way from and to the sample carrier 26 with the aid of a dichroitic and/or dielectric mirror 38; see the views in FIGS. 2B and 2C. The coupling of the radiation into and out of the reduced pressure chamber 20 is effected via a corresponding window 40 in the rear wall 20-1 of the chamber 20. With the aid of the UV-transparent objective 28 in the reduced pressure chamber 20, traversed both by the observation beam path 32 and the laser beam path 30, microscope viewing of the sample material 26 in transmission reflected light is firstly enabled, and focusing of the laser beam 30 on the front side of the sample carrier 24 bearing the sample material 26 onto a beam waist in the sub-micrometre range is secondly achieved.

Both beam paths 30, 32 pass through the sample carrier 24; the observation beam path 32 emanates from the interface of the sample material 26 with any matrix applied thereto and is imaged onto the light-sensitive chip of the observation camera 34. The image section depicted may have an edge length of 50-250 micrometres in which virtually no differences in contrast appear, and an optical resolution of 0.5-2 micrometres, depending on the choice of objective 28. The laser beam path 30 hits the reverse side of the same interface and is focused onto a small section of the sample material 26. This section corresponds to an image element or pixel for the MS measurement, for example having a size of 0.5-10 micrometres in diameter or edge length. The configuration is therefore that of a transmission MALDI (tMALDI) setup.

The embodiment shown is based on the dual utilization of a microscope objective 28 both for sample material observation and for sample material ablation. This dualism enables exact determination of the ablation point on the optical image generated. With the aid of tailored software, it is possible here to conjoin individual high-resolution microscope images to give a large overview image. At the same time, analysis of the contrast of microscope images with different object width enables assessment of topography with high spatial precision.

The observation is achieved by means of a camera 34 disposed along a surface normal of the sample carrier 26 and at a distance therefrom in the region to the rear outside the reduced pressure chamber 20. The objective 28 is infinitely corrected, and therefore an imaging lens 42 is positioned at a distance corresponding to its focal length from the camera 34. Microscope viewing in transmission reflected light (reflective), i.e. reflected back by the sample material 26 through the sample carrier, requires very diffuse illumination in order to reduce shadowing effects. This illumination is achieved in the present context by an illumination ring composed of several light-emitting diodes (LEDs) 44.

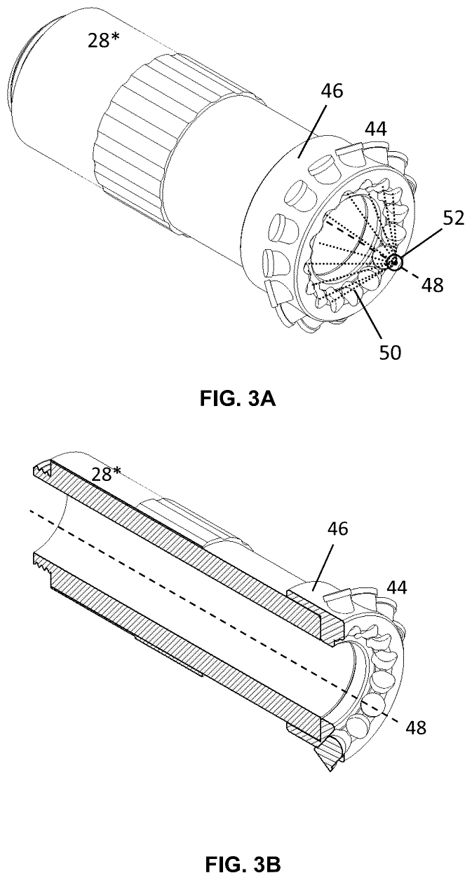

In the example shown, 15 LEDs 44 are used. The number of LEDs could also be smaller or greater. It is possible to use light sources or LEDs with white light characteristics or else monochromatic colour characteristics, e.g. green. Also conceivable are light sources or LEDs with variable colour characteristics that are tunable over a wavelength range, for example, or have mixed colours, especially polychromatic but non-white colour characteristics. The light-emitting diodes 44 are arranged in a cylindrical, axially projecting collar 46 which is joined to the objective body 28* to form an integral assembly, as shown in FIGS. 3A-B, and annularly encircle the optical observation axis 48 that runs through the objective 28. The light-emitting diodes 44 themselves are each accommodated in cylindrical housings embedded at a non-0° and non-180° angle from the optical observation axis 48 of the objective 28 in the collar 46, such that the optical axes (dotted lines 50) of all diodes 44 come to a focus or meet at a point 52 of maximum illumination on the optical observation axis 48 that is at a distance from the end of the collar of the objective body 28*. This point of maximum illumination 52 lies on the sample carrier 24 in order to be able to illuminate the sample material 26 placed on the front side thereof with high intensity and in a shadow-free manner in transmission reflected light, and corresponds to the optimal working distance for the objective 28 and/or the focal point thereof.

The laser radiation 30 for the ablation of the sample material 26 is adjusted to the envisaged section of the sample material 26 coaxially to the observation beam path 32 through the objective 28 with the aid of the dichroitic and/or dielectric mirror 38. This means that the ablation position is fixedly coupled to a defined position on the image observed. There is no need for subsequent error-prone co-registration of camera image and ablation position.

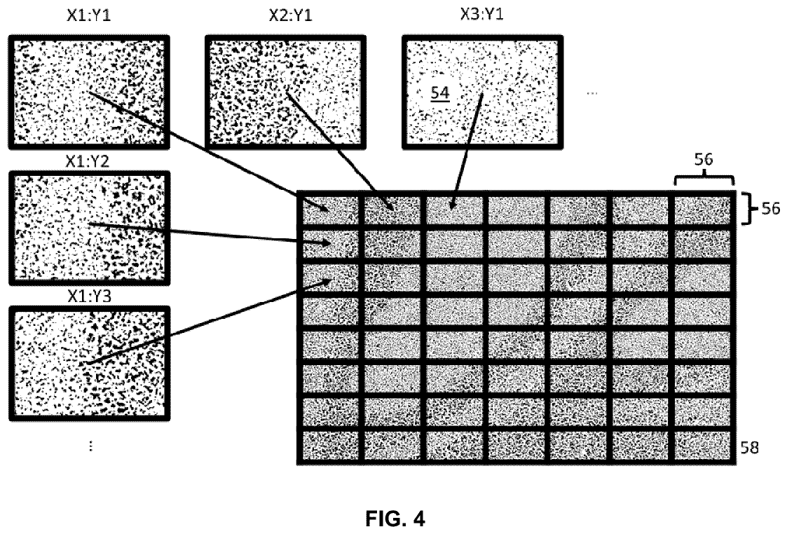

For the creation of an optical overview image (scan) with high resolution, individual images 54 of defined areas 56 on the sample carrier 26 are recorded with high resolution and joined in a mosaic-like manner to give an overall image 58. The corresponding principle is shown schematically in FIG. 4. For this purpose, camera 34 and movement mechanics of the displacement stage 22 are coordinated and synchronized on the software side. Subsequently, with the aid of the coordinates X:Y stored for each individual image 54, mosaic images are constructed. By virtue of exact positioning and minimal processing of the individual images 54, no distortion effects, for example stretching, rotation and the like, are introduced. Positioning accuracy is limited by the accuracy of the movement mechanics of the displacement stage 22 and the size of the optical pixel, i.e., depending on the scaling factor, is in the order of magnitude of 100 nanometres or even lower. Since the coordinates of the movement mechanics in the scanning of the sample material 26 remain constant in the laboratory positional coordinate system for the recording of the optical image and in a preceding or subsequent mass analysis, virtually perfect co-registration of the optical and molecular overall image is achieved without additional intervention or subsequent correction.

In order to determine the topography of the two-dimensional extended sample material 26 in a preferred embodiment, a defined set of points Xₙ:Yₘ is first selected over the entire scanning region, for example the total area of a tissue section. These may be fixed by instrument using a pattern or set manually. An autofocus routine is conducted using these points. The technique used here for determination of the focal plane at each individual point is similar to the method described by Michael J. Taylor et al.; see introduction. For any point on the sample material 26, it is possible by inter-and/or extrapolation, proceeding from the reference points of the selected points Xₙ:Yₘ, to calculate the true sample material elevation above the sample carrier 24 and introduce it as a software-side z correction. This method is especially suitable for correction of large-area topographical variances, as can arise in the clamping of the sample carrier 24 in the holder intended for the purpose.

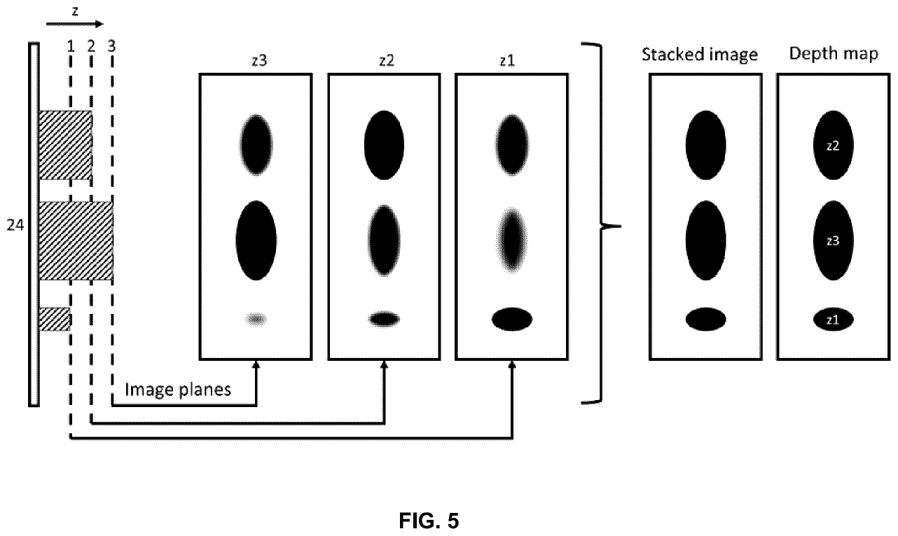

In a particular embodiment, a method based on focus stacking is employed. It is possible in this way to determine the topography of the sample material 26 in high lateral resolution, for example to a few micrometres. Analogously to the abovementioned method of creating an overall optical image, several overall optical images are created for defined z values using the movement space of the translation stage 22 in z direction with otherwise unchanged setting of the transmission reflected light optics system, indicated schematically in FIG. 5 as z1, z2, z3. Depending on the expected sample topography, these n values may cover, for example, a range from ±10 micrometres with a step width of 1 micrometre around a start value, for example an average or expected tissue section thickness.

A Laplace filter is applied to each of these images. The kernel size and the optional use of further filters is dependent on the optical configuration and on the observed sample material 26. The results from this step serve as a local measure for contrast or image sharpness and are written into a three-dimensional matrix. In this case, the first and second dimensions correspond to the x and y positions on the sample material 26; the third dimension corresponds to the z plane of the underlying image. For each x and y position, the maximum of the results matrix is determined in the third dimension. The z index of the maximum is written into a two-dimensional matrix for each x and y position, which can be referred to as depth or profile map; see far right in FIG. 5. The depth or profile map, optionally extended or supplemented by inter- and/or extrapolation, thus contains the z plane of the highest image sharpness at any x and y position.

The resultant depth or profile map can firstly be used to keep the ablation laser in focus to pixel accuracy during a subsequent MALDI-MSI analysis, for example by varying the focus position or by displacing the sample carrier along the z axis. On the other hand, it is possible to construct a focus stack image, labelled in FIG. 5 as “stacked image”. In this case, the true pixel intensities of the recorded z planes are conjoined pixel by pixel such that a resultant image includes only the image data of the respective sharpest z plane at the respective xy position. This procedure, especially owing to the constantly sharp representation, significantly facilitates visual evaluation of the overall light microscopy image information and visual matching thereof with the molecular image information.

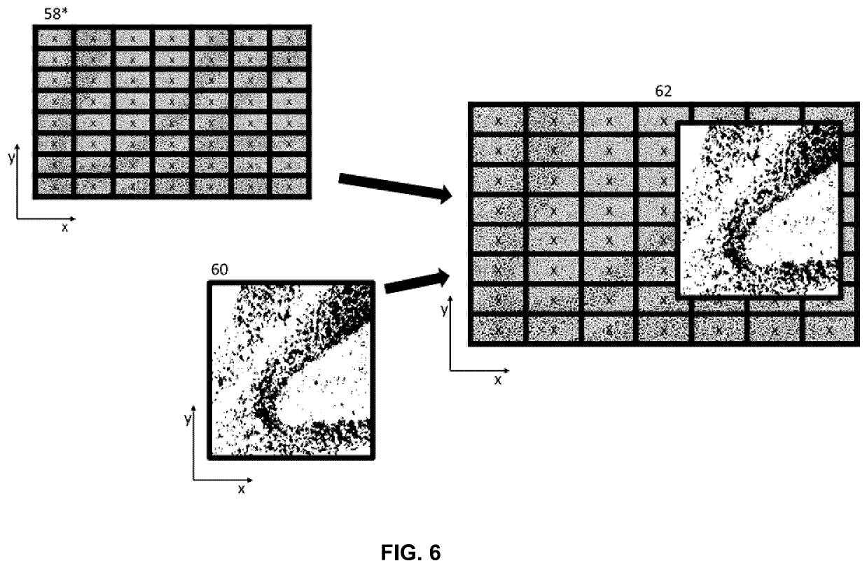

The above-described techniques distinctly facilitate and improve the procedure and/or accuracy for a tMALDI-MSI analysis with small pixel sizes. FIG. 6 illustrates the co-registration of the spatially resolved light microscopy image information, represented by an overall optical image 58* top left, the individual image grids of which are identified by black bars, and individual image centre coordinates by crosses. The dimensions of each individual image and the location thereof in the coordinate system are stored for a particular translation stage position. Likewise shown is the spatially resolved molecular image information, represented by the ion image 60 bottom left, which shows, for example, the intensity distribution of a particular ion or molecular species of interest, for example a protein, peptide, lipid, polynucleotide or polysaccharide. The information from the two modalities can then be associated to give overall image information, which-owing to detection in the same coordinate system-has been co-registered with high spatial resolution in the sub-micrometre range, represented by the composite diagram 62 on the right. The co-registered overall image information, having a light microscopy image component and a molecular image component, can then be visually assessed by a user or subjected to a computer-assisted automated evaluation routine, for example for discovery of feature correlations in the data from the various modalities.

FIG. 7 shows a schematic of a fundamentally known MALDI time-of-flight mass analyser in an axial reflector setup, in which principles of the present disclosure may be used. The sample material is present on the sample carrier plate 71 opposite the acceleration electrodes 72 and 73 and can be ionized in a spatially resolved manner by the laser light pulse beam 74, 74* supplied by the laser 75, 75* in reflected light or transmitted light. The ions are accelerated by the acceleration electrodes 72 and 73 to give an ion beam 78, which passes through a gas cell 79 that can be filled with collision gas if required, a precursor ion selector 80, a fragment ion post-acceleration unit 81 and the precursor ion suppressor 82, and then reflected by the reflector 83 onto the ion detector 84. The housing of the mass analyser is pumped by a high-powered vacuum pump 85. The ion detector 84 may have a multi-channel plate as ion receiver. It is possible to integrate a transmission reflected light optics system according to the principles of the present disclosure into the rear portion behind the sample carrier 71.

The invention is described above with regard to various particular working examples. However, it will be apparent that various features or details of the executions described can be altered without deviating from the scope of the invention. In addition, the features and measures disclosed in association with different embodiments may be combined as desired, if this seems practicable to a person skilled in the art. Moreover, the present description serves merely for illustration of the invention and not for restriction of the scope of protection, which is defined exclusively by the appended claims with regard to any existing equivalents.

1. An apparatus for multimodal analysis of sample material, comprising:
a desorption optics system that subjects sample material disposed on one side of a sample carrier to a first radiation that desorbs the sample material into a gas phase, with ionization of the desorbed sample material,
an analyser disposed at a distance from the sample carrier that receives the desorbed and ionized sample material and processes it to spatially resolved molecular image information,
a transmission reflected light optics system that records light microscopy image information from the sample carrier and sample material in a spatially resolved manner using a second radiation in reflection through the transparent sample carrier, where the second radiation is emitted by a light source disposed on a side of the sample carrier facing away from the sample material such that the second radiation, when incident on the sample carrier, does not pass through any optics component through which the first radiation passes when incident on the sample carrier, and
a computation unit that communicates with the desorption optics system, the analyser and the transmission reflected light optics system, and that associates the spatially resolved molecular image information and the spatially resolved light microscopy image information to give spatially resolved co-registered overall image information.

2. The apparatus according to claim 1, wherein the desorption optics system comprises a transmitted light optics system configured such that the first radiation is incident on the sample material after passing through the sample carrier.

3. The apparatus according to claim 2, wherein an observation axis of the transmission reflected light optics system and an optical axis of the first radiation incident on the sample carrier are aligned using a dichroitic and/or dielectric mirror.

4. The apparatus according to claim 1, wherein the sample carrier comprises a conductively coated glass plate.

5. The apparatus according to claim 1, wherein the light source is configured such that spatially resolved light microscopy image information is recorded in a substantially shadow-free manner.

6. The apparatus according to claim 1, wherein the light source is annular, and an observation axis of the transmission reflected light optics system is encircled by the second radiation.

7. The apparatus according to claim 1, wherein the light source comprises a plurality of light-emitting diodes.

8. The apparatus according to claim 1, wherein the light source is configured such that the second radiation, when incident on the sample carrier, does not pass through any imaging and/or deflecting optics component.

9. The apparatus according to claim 1, wherein the sample carrier, comprises movement mechanics that move it in at least one spatial direction with respect to a direction of incidence of the first radiation and/or of the second radiation.

10. The apparatus according to claim 1, wherein a mode of operation of the computation unit, of the desorption optics system and of the transmission reflected light optics system includes recording the spatially resolved light microscopy image information before and/or after exposure of the sample material to the first radiation.

11. The apparatus according to claim 1, further comprising an imaging objective arranged such that the light source lies between the sample carrier and the objective along an observation axis of the transmission reflected light optics system.

12. The apparatus according to claim 11, wherein the imaging objective focuses the first radiation onto the sample carrier and images the second radiation after passage through the sample carrier and reflection from the sample material.

13. The apparatus according to claim 11, wherein the light source and the imaging objective are part of an integral assembly.

14. The apparatus according to claim 1, wherein a mode of operation of the computation unit and of the transmission reflected light optics system includes recording the spatially resolved light microscopy image information by sequentially scanning a multitude of xy individual image areas on the sample material and computationally conjoining the isolated xy individual image information thusly obtained.

15. An apparatus for multimodal analysis of sample material, comprising:
a desorption optics system that subjects sample material disposed on one side of a sample carrier to a first radiation that desorbs the sample material into the a gas phase, with ionization of the desorbed sample material,
an analyser disposed at a distance from the sample carrier that receives the desorbed and ionized sample material and processes it to spatially resolved molecular image information,
a transmission reflected light optics system that records light microscopy image information from the sample carrier and sample material in a spatially resolved manner using a second radiation in reflection through the transparent sample carrier, wherein the second radiation is emitted by a light source disposed on a side of the sample carrier facing away from the sample material and designed such that the spatially resolved light microscopy image information is recorded in a substantially shadow-free manner, and
a computation unit that communicates with the desorption optics system, the analyser and the transmission reflected light optics system, and that associates the spatially resolved molecular image information and the spatially resolved light microscopy image information to give spatially resolved co-registered overall image information,
wherein a mode of operation of the computation unit and of the transmission reflected light optics system includes recording the spatially resolved light microscopy image information by sequentially scanning a multitude of xy individual image areas on the sample material and computationally conjoining the isolated xy individual image information thusly obtained.

16. The apparatus according to claim 14, wherein a mode of operation of the computation unit and of the transmission reflected light optics system includes scanning a multitude of xy individual image areas in a third spatial direction z for a maximum contrast and/or image sharpness position.

17. The apparatus according to claim 16, wherein a mode of operation of the computation unit and of the transmission reflected light optics system includes using the maximum contrast and/or image sharpness position (i) to ascertain spatially resolved height profile information of the sample material above the sample carrier and/or (ii) to assemble an optical overall image having an image component from a z position of the respective maximum contrast and/or image sharpness position in each image element.

18. The apparatus according to claim 16, wherein a mode of operation of the computation unit and of the desorption optics system includes using the maximum contrast and/or image sharpness position in the exposure of the sample material for an adjustment of a position of the (i) focus of the first radiation and/or (ii) sample carrier in the third spatial direction z.

19. A method of multimodal analysis of sample material, comprising:
locally exposing the sample material disposed on one side of a sample carrier to a first radiation that desorbs the sample material into a gas phase, with ionization of the locally desorbed sample material,
receiving and processing the locally desorbed and ionized sample material to generate spatially resolved molecular image information using an analyser disposed at a distance from the sample carrier,
recording spatially resolved light microscopy image information from the sample carrier and sample material using a second radiation in reflection through the transparent sample carrier, wherein the second radiation is emitted by a light source disposed on a side of the sample carrier facing away from the sample material and configured such that the second radiation, when incident on the sample carrier, does not pass through any optics component through which the first radiation passes when incident on the sample carrier, and
associating the spatially resolved molecular image information and the spatially resolved light microscopy image information to give spatially resolved co-registered overall image information.

20. A method of multimodal analysis of sample material, comprising:
locally exposing the sample material disposed on one side of a sample carrier to a first radiation that desorbs the sample material into a gas phase, with ionization of the locally desorbed sample material,
receiving and processing the locally desorbed and ionized sample material to generate spatially resolved molecular image information using an analyser disposed at a distance from the sample carrier,
recording spatially resolved light microscopy image information from the sample carrier and sample material using a second radiation in reflection through the transparent sample carrier, where the second radiation is emitted by a light source disposed on a side of the sample carrier facing away from the sample material and designed such that the spatially resolved light microscopy image information is recorded in a substantially shadow-free manner, and
associating the spatially resolved molecular image information and the spatially resolved light microscopy image information to give spatially resolved co-registered overall image information,
wherein the spatially resolved light microscopy image information is recorded by sequentially scanning a multitude of xy individual image areas on the sample material and computationally conjoining the isolated xy individual image information thusly obtained.

21. (canceled)
